(19) United States
(12) Patent Application Publication
(10) Pub. No.: US 2016/0264805 A1
(43) Pub. Date: Sep. 15, 2016

(54) SOLVENT-BASED INK JET INK COMPOSITION

(71) Applicant: Seiko Epson Corporation, Tokyo (JP)

(72) Inventors: Makoto NAGASE, Shiojiri (JP); Kenichiro KUBOTA, Matsumoto (JP); Jun ITO, Shimosuwa (JP); Naoki KOIKE, Matsumoto (JP); Shugo HATTORI, Shiojiri (JP)

(21) Appl. No.: 15/064,732

(22) Filed: Mar. 9, 2016

(30) Foreign Application Priority Data
Mar. 10, 2015 (JP) 2015-047608

(51) Int. Cl. C09D 11/36

(52) U.S. Cl. CPC C09D 11/36

(57) ABSTRACT

A solvent-based ink jet ink composition includes a pigment, a solvent a that is a cyclic ester; and a solvent b with a lower dissolving power of polyvinyl chloride than the solvent a, in which a content of the solvent a is 1.0 to 7.0 mass %, and a content of the solvent b is 10 parts by mass or more to one part by mass of the content of the solvent a.

### BACKGROUND

1. Technical Field

The present invention relates to a solvent-based ink jet ink composition and an ink jet recording method.

2. Related Art

The ink jet recording method is able to record high definition images with a comparatively simple device, and rapid development has been made on various fronts. Among these, various investigations have been made into discharge stability or the like. JP-A-2012-12432 discloses an oil-based ink jet ink that has the advantage providing an oil-based ink jet ink with excellent permeation and drying properties, that can suppress roller transfer contamination of the printed matter, and also has excellent discharge stability, and storage stability, the oil-based ink jet ink that includes at least a pigment, a pigment dispersant, and a solvent including a hydrocarbon solvent (A), a solvent (B) having at least an ester group and an ether group in one molecule and solvent (C) that dissolves in a hydrocarbon solvent and a solvent having at least an ester group and an ether group in one molecule.

However, in a case of using a solvent with low permeability (the resin dissolving power is low) as in JP-A-2012-12432, the ink composition is not easily fixed and the color fastness to rubbing of the recording material is lowered in a vinyl chloride medium widely applied to a recording medium for signage. This is caused by the solvent not easily dissolving the vinyl chloride, and the fixing power of the ink composition to the recording medium being low. In a case of dissolving the fixing resin to blend with the ink composition with the advantage of improving the color fastness to rubbing, the dissolving power may be insufficient and it may be difficult to blend a sufficient amount of the fixing resin. Furthermore, because the ink composition does not permeate in the depth direction of the recording medium, and wets and spreads on the surface when large amounts of solvent with a low resin dissolving power is blended, even though the fillability of the recording material is improved, bleeding and printing unevenness of the printed matter worsen. Meanwhile, because the ink composition permeates in the depth direction of the recording medium when large amounts of solvent with a high resin dissolving power is blended, the ink composition does not easily spread on the surface, and the fillability and the leveling properties (glossiness) of the recording material worsen.

### SUMMARY

An advantage of some aspects of the invention is to provide a solvent-based ink jet ink composition and an ink jet recording method able to obtain a recording material with excellent drying properties, color fastness to rubbing, and excellent fillability, such as gloss or dot size.

The inventors have conducted intensive research in order to achieve the above advantages. As a result, it was discovered that it is possible to achieve the advantage by using a predetermined solvent composition, thereby completing invention.

That is, the invention is as follows.
[1] According to an aspect of the invention, there is provided a solvent-based ink jet ink composition including a pigment; a solvent a that is a cyclic ester; and a solvent b with a lower dissolving power of polyvinyl chloride than the solvent a, in which a content of the solvent a is 1.0 to 7.0 mass %, and a content of the solvent b is 10 parts by mass or more to one part by mass of the content of the solvent a.
[2] In the solvent-based ink jet ink composition according to [1], the pigment may include a white pigment.
[3] The solvent-based ink jet ink composition according to [1] or [2] may further include a glycol monoether solvent, in which a content of the glycol monoether solvent is 4.0 to 20 mass %.
[4] In the solvent-based ink jet ink composition according to any one of [1] to [3], the solvent b may include a compound represented by the following formula (1).

R¹O—(R²O)ₘ—R³ Formula (1)

(in the formula, R¹ is a hydrogen atom or an alkyl group with 1 to 4 carbon atoms, R² is an alkylene group with 2 or carbon atoms, R³ is an alkyl group with 1 to 4 carbon atoms, and m is an integer of 2 to 4.)
[5] In the solvent-based ink jet ink composition according to any one of [1] to [4], the solvent b may include a compound b1 with a flash point of 70° C. or less, and a content of the compound b1 may be 50 mass % or more to the total amount of the solvent b.
[6] In the solvent-based ink jet ink composition according to [5], the content of the compound b1 may be 10 parts by mass or more to one part by mass of the content of the solvent a.
[7] In the solvent-based ink jet ink composition according to any one of [1] to [6], the solvent-based ink jet ink composition may be used in an ink jet recording method that includes attaching in which the solvent-based ink jet ink composition is attached to a recording medium, and the ink jet recording method may include attaching in which an attachment amount in an attachment region of the recording medium is 10 to 70 mg/inch².
[8] The solvent-based ink jet ink composition according to any one of [1] to [7] may further include water, and a content of the water may be 3.0 mass % or less.
[9] According to another aspect of the invention, there is provided an ink jet recording method, including attaching the solvent-based ink jet ink composition according to any one of [1] to [8] to a recording medium.

### DESCRIPTION OF EXEMPLARY EMBODIMENTS

Below, although modes for carrying out the invention (below, referred to as “embodiments”) is described in detail, the invention is not limited thereto, and various modifications are possible in a range not departing therefrom. The wording “(meth)acrylate” in the specification signifies both an acrylate and a methacrylate corresponding thereto.

### Solvent-Based Ink Jet Ink Composition

The solvent-based ink jet ink composition of the embodiment (below, also referred to simply as “ink composition”) contains a pigment, a solvent a that is a cyclic ester, and a solvent b with a lower dissolving power of polyvinyl chloride than the solvent a, in which the content of the solvent a is 1.0 to 7.0 mass %, and the content of the solvent b is 10 parts by mass or more to one part by mass of the content of the solvent a.

The solvent-based ink composition is an ink composition not containing water as a functional component for exhibiting the functions and capacities of the ink, rather than having water as the main solvent component. The content of water to the ink composition is 5 mass % or less, is preferably 3 mass % or less, more preferably 1 mass % or less, particularly preferably 0.5 mass % or less, still more preferably 0.1 mass % or less, and may further not contain water. The content of the solvent in the solvent-based ink is preferably 50 mass % or more and more preferably 70 to 98 mass %. It is preferable to use a non-photocurable ink with which recording is performed by drying the solvent by heating or at room temperature for the solid content to be fixed, after being attached onto the recording medium. Although a photocurable ink that is cured by radiating radiation (light) may be used, a non-photocurable ink with the feature that the radiating of radiation is unnecessary is preferable.

The solvent included in the solvent-based ink jet ink composition has various functions. A solvent with a low boiling point has good drying properties and favorable printing unevenness, and a solvent with a high boiling point dries slowly and has improved fillability and glossiness of the recording material obtained. The solvent that easily dissolves the recording medium has improved color fastness to rubbing of the obtained recording material and the solvent that does not easily dissolve the recording medium has superior wetting and spreading, and improved fillability and glossiness of the obtained recording material.

In such a viewpoint, the cyclic ester solvent has the advantages of being a solvent that relatively easily dissolves a low-absorbency recording medium such as polyvinyl chloride, and is capable of obtaining a recording material with superior color fastness to rubbing. The drying properties are also favorable. Meanwhile, when the behavior of the cyclic ester solvent on the recording medium is observed, there is a problem that, since the recording medium is easily dissolved in the thickness, the ink does not sufficiently spread in the surface direction.

In contrast, it is possible for the ink composition of the embodiment to obtain a recording material that is superior in both of color fastness to rubbing and fillability, by having a predetermined solvent constitution. Below, each component will be described.

### Pigments

Although not particularly limited, examples of the pigment include the following.

Although not particularly limited, examples of the black pigment include No. 2300, No. 900, MCF 88, No. 33, No. 40, No. 45, No. 52, MA7, MA8, MA100, No. 2200B and the like (all manufactured by Mitsubishi Chemical Corporation); Raven 5750, Raven 5250, Raven 5000, Raven 3500, Raven 1255, Raven 700 and the like (all manufactured by Carbon Columbia Co., Ltd.); Regal 400R, Regal 330R, Regal 660R, Mogul L, Monarch 700, Monarch 800, Monarch 880, Monarch 900, Monarch 1000, Monarch 1100, Monarch 1300, Monarch 1400 and the like (manufactured by Cabot Japan K.K.); and Color Black FW1, Color Black FW2, Color Black FW2V, Color Black FW18, Color Black FW200, Color Black 5150, Color Black 5160, Color Black S170, Printex 35, Printex U, Printex V, Printex 140U, Special Black 6, Special Black 5, Special Black 4A, and Special Black 4 (all manufactured by Degussa AG).

Although not particularly limited, examples of the white pigment include white inorganic pigments such as C.I. Pigment White 6, 18, and 21, titanium oxide, zinc oxide, zinc sulfide, antimony oxide, and zirconium oxide. It is possible to use a white organic pigment, such as white hollow resin particles and polymer particles, in addition to the white inorganic pigments.

Although not particularly limited, examples of the pigment used in the yellow ink include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Although not particularly limited, examples of the magenta pigment include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245, or C.I. Pigment Violet 19, 23, 32, 33, 36, 38, 43, and 50.

Although not particularly limited, examples of the cyan pigment include C.I. Pigment Blue 1, 2, 3, 15, 15:1, 15:2, 15:3, 15:34, 15:4, 16, 18, 22, 25, 60, 65, and 66, and C.I. Vat Blue 4, and 60.

Although not particularly limited, examples of pigments used in the color ink other than magenta, cyan, and yellow include C.I. Pigment Green 7 and 10, C.I. Pigment Brown 3, 5, 25, and 26, and C.I. Pigment Orange 1, 2, 5, 7, 13, 14, 15, 16, 24, 34, 36, 38, 40, 43, and 63.

Although not particularly limited, examples of the pearl pigment include pigments having pearl gloss or interference gloss, such as titanium dioxide-coated mica, scale foil, and bismuth acid chloride.

Although not particularly limited, examples of the metallic pigment include particles formed from simple metals or alloys such as aluminum, gold, platinum, nickel, chromium, tin, zinc, indium, titanium, and copper.

Among these, a white pigment is preferable. The problem of the lowering of the image quality of the recording material derived from the lowering of the fillability becomes more remarkable in an ink composition including a white pigment in which high concealment is demanded in addition to being able to recorded an undercoat. For example, the ink composition including the white pigment is applied on the recording medium in large amounts with the advantage of improving the fillability when used as an undercoat. However, in a case where the wetting and spreading of the ink composition on the recording medium is insufficient, it is difficult to obtain an undercoat with good fillability. Moreover, because large amounts of the ink composition is provided as the undercoat at the outset, if the fillability is ensured by further increasing the application amount of the ink composition, there is a problem of lowering of the printing speed and the drying properties. Also in a case where the ink composition including the white pigment is used on a transparent film in order to express snow or the like, an image with good fillability similar to the above is obtained. From such a viewpoint, the ink composition of the embodiment is particularly preferable in the ink composition including the white pigment.

In a case where the wetting and spreading is insufficient and the fillability is lowered for the ink composition on the recording medium, the ink composition of the embodiment is also particularly preferable in an ink composition including a color pigment because the width of the lines drawn is lowered.

It is preferable that the content of the pigment is to 25 mass % with respect to the total amount of the composition, 12.5 to 20 mass % is more preferable, and 15 to 17.5 mass % is still more preferable.

### Solvent a

The solvent a is a cyclic ester. Although not particularly limited, examples of the cyclic ester include a γ-lactone with a 5-member ring structure or a δ-lactone with a γ-member ring structure, and a ε-lactone with a 7-member structure, that are compounds having a ring structure due to an ester bond. Specifically, examples thereof include γ-butyrolactone, γ-valerolactone, γ-hexalactone, γ-heptalactone, γ-octalactone, γ-nonalactone, γ-decalactone, γ-undecalactone, δ-valerolactone, δ-hexalactone, δ-heptalactone, δ-octalactone, δ-nonalactone, δ-decalactone, δ-undecalactone, and ε-caprolactam. Among these, a lactone with a 5-member ring structure, and a γ-butyrolactone is more preferable.

It is preferable that the content of the solvent a is 1.0 to 7.0 mass % with respect to the total amount of the ink composition, 2.0 to 6.0 mass % is more preferable, and 2.0 to 5.0 mass % is still more preferable. By the content of the solvent a being 1.0 mass % or more, the abrasion resistance of the obtained recording material is improved. By the content of the solvent a being 7.0 mass % or less, the fillability of the obtained recording material is further improved.

### Solvent b

The solvent b is a solvent with a lower dissolving power of polyvinyl chloride than the solvent a. In the embodiment, the wording “dissolving power of polyvinyl chloride” is defined by the following PVC solubility test.

### PVC Solubility Test

0.5 g of polyvinyl chloride (PVC Straight Polymer TK-800, Shin-Etsu Chemical Co., Ltd.) and 50 g of solvent were mixed in a glass bottle, and stirred for five minutes at 25° C. Thereafter, the resultant was left to stand, and the height X of the solvent liquid surface from the bottom of the glass bottle and the height Y from the bottom of the glass bottle in which the swollen or dissolved polyvinyl chloride power is distributed were measured at 25 seconds after being left. The ratio Y/X is obtained with the obtained X and Y and made the index of the dissolving power of polyvinyl chloride.

The dissolution of the polymer proceeds to a state (dissolve) which begins from the swelling due to the solvent entering between the polymer chains, and the polymer is dispersed to an extent where it is not observable visually. In this testing, the higher the dissolving power of polyvinyl chloride of the solvent, the more the polyvinyl chloride powder swells, and the lighter the specific gravity becomes per volume. The more swollen polyvinyl chloride present, the more slowly the powder precipitates when left to stand. Accordingly, the dissolving power of polyvinyl chloride can be relatively stipulated by obtaining the ratio Y/X at 25 seconds from being left to stand. In a case where the all of the polyvinyl chloride powder is dissolved by stepwise stirring, although it is difficult to obtain the ratio Y/X because it is difficult to measure Y, it is clearly possible to regard this case as a solvent with a high dissolving power of polyvinyl chloride.

In a case of a low dissolving power of polyvinyl chloride of the solvent, because the proportion of undissolved polyvinyl chloride present increases, the polyvinyl chloride gathers in the vicinity of the bottom. That is, the ratio Y/X decreases. Meanwhile, in a case where the dissolving power of polyvinyl chloride of the solvent is high, because the proportion of the swollen portion of the polyvinyl chloride present increases, Y increases. That is, the ratio Y/X increases. In a case where the dissolving power of polyvinyl chloride of the solvent is still higher, when the polyvinyl chloride is completely dissolved, the PVC that gathers at the bottom portion is lost.

When γ-butyrolactone that is a cyclic ether is tested with the above method, Y/X=0.8. In a case where the PVC solubility index of γ-butyrolactone becomes a value range of 0.7≦Y/X≦0.9, the solubility of various types of solvent becomes as follows.

Solvents for which Y/X is greater than 0.9 and a higher dissolving power of polyvinyl chloride than γ-butyrolactone: 1,3-dioxolan, ethylene glycol dimethyl ether, ethylene glycol-monophenyl ether, N,N-dimethyl-β-methoxypropionamide (manufactured by Idemitsu Kosan Co., Ltd. trade name: Equamide M100)

Solvents for which Y/X is 0.7 or more to 0.9 or less and the same dissolving power of polyvinyl chloride as γ-butyrolactone: diethylene glycol monomethyl ether, dimethyl succinic acid, diethyl succinic acid, tetraethylene glycol dimethyl ether, dipropylene glycol monomethyl ether, triethylene glycol dimethyl ether, diethylene glycol dimethyl ether, triethylene glycol butylmethyl ether.

Solvents for which Y/X is less than 0.7, and a lower dissolving power of polyvinyl chloride than γ-butyrolactone: 1,4-dioxane, diethylene glycol dibutyl ether, diethylene glycol methylethyl ether, diethylene glycol diethyl ether, diethylene glycol butylmethyl ether, dipropylene glycol dimethyl ether, propylene glycol dimethyl ether, dimethyl sulfoxide, tetraethylene glycol monobutyl ether, pentaethylene glycol monobutyl ether.

In this way, in the embodiment, the Y/X of solvent a is measured, and a solvent with a Y/X of more than +0.1 is solvent d with a higher dissolving power of polyvinyl chloride than the solvent a, a solvent in a value region of Y/X−0.1 to Y/X+0.1 is a solvent c with the same dissolving power of polyvinyl chloride as the solvent a, and a solvent with Y/X less than −0.1 is the solvent b with a lower dissolving power of polyvinyl chloride than the solvent a. A solvent for which Y is difficult to measure is also the solvent d with a higher dissolving power of polyvinyl chloride than the solvent a. In a case of using two or more types of solvent a, the Y/X is measured for each solvent a and the measured Y/X and the average value of the content of each solvent a is the dissolving power. In a case of using the solvent al in which Y/X is A and the solvent a2 in which Y/X is B, it is possible for the dissolving power of the solvent a to be obtained with the following formula. Dissolving Power=(A×content of solvent a1+B×content of solvent a2)/(content of solvent a1+content of solvent a2)

It is possible to also obtain the Y/X of a cyclic ester other than γ-butyrolactone with the same method as above.

Although not particularly limited, examples of the solvent b include a glycol monoether solvent, a glycol diether solvent, and a cyclic ether solvent. Among these, a glycol monoether solvent and a glycol diethyl solvent are preferable. By using such solvents, the fillability of the obtained recording material tends to further improve.

Although not particularly limited, examples of the glycol monoether solvent and the glycol diether solvent include the compounds represented by the following formula (1). By using such solvents, the fillability of the obtained recording material tends to further improve.

R¹O—(R²O)ₘ—R³ Formula (1)

(in the formula, R¹ is a hydrogen atom or an alkyl group with 1 to 4 carbon atoms, R² is an alkylene group with 2 or carbon atoms, R³ is an alkyl group with 1 to 4 carbon atoms, and m is an integer of 2 to 4.)

It is preferable to use a compound b1 with a flash point of 70° C. or less as the solvent b. Although not particularly limited, examples of the compound b1 with a flash point of 70° C. or less include glycol diethyl ether (35° C.), ethylene glycol dimethyl ether (−6° C.), diethylene glycol methylethyl ether (63° C.), diethylene glycol dimethyl ether (56° C.), dipropylene glycol dimethyl ether (56° C.), and propylene glycol dimethyl ether (6.5° C.) (numbers in parentheses indicate flash point).

The wording “flash point” indicates the flash point according to a Cleveland open-cup flash tester in a case where the flash point according to a Tagliabue closed cup flash tester is not 80° C. or less, and in cases where the flash point according to the Tagliabue closed cup flash tester is 80° C. or less, indicates the flash point according to a Tagliabue closed cup flash tester in a case where the kinematic viscosity of the solvent at the flash point is 10 cSt, and indicates the flash point according to a Tagliabue closed cup flash tester in a case where the kinematic viscosity at the flash point is 10 cSt or more.

It is preferable that the content of the compound b1 is 30 mass % or more to the total amount of the solvent b, 40 mass % or more is more preferable, and 50 mass % or more is still more preferable. It is preferable that the content of the compound b1 is 70 mass % or less to the total amount of the solvent b. By the content of the compound b1 being 30 mass % or more, there is a tendency for the drying properties to improve, for printing unevenness in the obtained recording material to be suppressed, and for the dot size to increase. By the content of the solvent b1 being 70 mass % or less, the glossiness of the obtained recording material tends to further improve.

It is preferable that the content of the solvent b1 is 5.0 parts by mass or more to one part by mass of the content of the solvent a, 10 parts by mass or more is more preferable, and 15 parts by mass or more is still more preferable. The content of the compound b1 is preferably 20 parts by mass or less to one part by mass of the content of the solvent a. By the content of the compound b1 being 5.0 parts by mass or more, the drying properties tend to improve and the dot size to increase. By the content of the compound b1 being 20 parts by mass or less, the color fastness to rubbing tends to further improve.

It is preferable to use a compound b2 with a flash point of more than 70° C. as the solvent b. Although not particularly limited, examples of the compound b2 with a flash point of more than 70° C. include diethylene glycol dimethyl ether (70.8° C.), diethylene glycol monobutyl ether (78° C.), dipropylene glycol monomethyl ether (79° C.), ethylene glycol diethyl ether (85° C.), diethylene glycol monoethyl ether (86° C.), diethylene glycol monomethyl ether (93° C.), diethylene glycol monobutyl methyl ether (94° C.), triethylene glycol dimethyl ether (111° C.), diethylene glycol dibutyl ether (118° C.), triethylene glycol monoethyl ether (135° C.), triethylene glycol monomethyl ether (138° C.), tetraethylene glycol dimethyl ether (141° c), triethylene glycol monobutyl ether (143° C.), tetraethylene glycol monomethyl ether (161° C.), and tetraethylene glycol monobutyl ether (177° C.) (numbers in parentheses indicate flash point).

It is preferable that the content of the compound b2 is 15 mass % or more to the total amount of the solvent b, 20 mass % or more is more preferable, and 25 mass % or more is still more preferable. It is preferable that the content of the compound b2 is 70 mass % or less to the total amount of the solvent b, 50 mass % or less is more preferable, and 35 mass % or less is still more preferable. By the content of the compound b2 being 15 mass % or more, the color fastness to rubbing of the obtained recording material tends to further improve. By the content of the compound b2 being 35 mass % or less, there is a tendency for the drying properties to improve, for printing unevenness in the obtained recording material to be suppressed, and for the dot size to increase.

It is preferable that the content of the solvent b is 40 to 75 mass % with respect to the total amount of the ink composition, 45 to 70 mass % is more preferable, and 50 to 70 mass % is still more preferable. By the content of the solvent b being 40 mass % or more, the glossiness of the obtained recording material tends to further improve. By the content of the solvent b being 75 mass % or less, the color fastness to rubbing of the obtained recording material tends to further improve.

The content of the solvent b is 10 parts by mass or more to one part by mass of the content of the solvent a, 12.5 parts by mass or more is preferable, and 15 parts by mass or more is still more preferable. It is preferable that the content of the solvent b is 35 parts by mass or less to one part by mass of the content of the solvent a, 30 parts by mass or less is preferable, and 25 parts by mass or less is still more preferable. By the content of the solvent b being 10 parts by mass or more, the gloss of the obtained recording material tends to further improve. By the content of the solvent b being 35 parts by mass or less, the printing unevenness in the obtained recording material is suppressed, and the dot size tends to further improve.

### Solvent c

The ink composition of the embodiment may further contain the solvent c with the same dissolving power of polyvinyl chloride as the solvent a. Although not particularly limited, examples of the solvent c include a glycol monoether solvent, a glycol diether solvent, and an ester solvent.

It is preferable that the content of the solvent c is 5.0 to 35 mass % with respect to the total amount of the ink composition, 7.5 to 32.5 mass % is more preferable, and 10 to 30 mass % is still more preferable. By the content of the solvent c being 5.0 mass % or more, the color fastness to rubbing of the obtained recording material tends to further improve. By the content of the solvent c being 35 mass % or less, the gloss of the obtained recording material tends to further improve.

It is preferable that the content of the solvent c is 1.0 to 12.5 parts by mass to one part by mass of the content of the solvent a, 2.5 to 10 parts by mass or more is preferable, and 5.0 to 7.5 parts by mass or more is still more preferable. By the content of the solvent c being 1.0 parts by mass or more, the color fastness to rubbing of the obtained recording material tends to further improve. By the content of the solvent c being 12.5 parts by mass or less, the gloss of the obtained recording material tends to further improve.

### Solvent d

The ink composition of the embodiment may further contain a solvent d with a higher dissolving power of polyvinyl chloride than the solvent a. Although not particularly limited, examples of the solvent d include a glycol monoether solvent, a glycol diether solvent, a cyclic ether solvent, and an amide-based solvent.

It is preferable that the content of the solvent d is 1.0 to 12.5 mass % with respect to the total amount of the ink composition, 1.5 to 10 mass % is more preferable, and 2.5 to 7.5 mass % is still more preferable. By the content of the solvent d being 1.0 mass % or more, the color fastness to rubbing of the obtained recording material tends to further improve. By the content of the solvent d being 12.5 mass % or less, the drying properties tend to improve and the dot size to further increase.

The content of the solvent d is 0.25 to 1.75 parts by mass to one part by mass of the content of the solvent a, 0.50 to 1.5 parts by mass or more is preferable, and 0.75 to 1.25 parts by mass or more is still more preferable. By the content of the solvent d being 0.25 parts by mass or more, the color fastness to rubbing of the obtained recording material tends to further improve. By the content of the solvent d being 1.75 parts by mass or less, the drying properties tend to improve and the dot size to further increase.

### Glycol Monoether Solvent

The ink composition of the embodiment preferably includes a glycol monoether solvent. By including a glycol monoether solvent, the drying properties tend to improve and the dot size to further increase. The glycol monoether solvent may be a solvent corresponding to the solvents b to d. That is, the glycol monoether solvent may be a solvent with a higher dissolving power of polyvinyl chloride than the solvent a, may be a solvent with the same dissolving power of polyvinyl chloride as the solvent a, or may be a solvent with a lower dissolving power of polyvinyl chloride than the solvent a.

Although not particularly limited, examples of the glycol monoether solvent include the compounds represented by the following formula (2).

R¹O—(R²O)ₘ—H Formula (2)

(in the formula, R¹ is an alkyl group with 1 to 4 carbon atoms, R² an alkylene group with 2 to 3 carbon atoms, and m is an integer of 2 to 4)

Although not particularly limited, examples of such a glycol monoether include ethylene glycol mono isopropyl ether (44° C.), ethylene glycol monoethyl ether (43° C.), ethylene glycol monobutyl ether (60° C.), ethylene glycol monomethyl ether (41° C.), diethylene glycol monomethyl ether (86° C.), diethylene glycol monobutyl ether (78° C.), diethylene glycol monomethyl ether (93° C.), dipropylene glycol monomethyl ether (79° C.), dipropylene glycol monobutyl ether (96° C.), tetraethylene glycol monomethyl ether (161° C.), triethylene glycol monomethyl ether (138° C.), triethylene glycol monoethyl ether (135° C.), triethylene glycol monobutyl ether (143° C.), propylene glycol monoethyl ether (38.5° C.), and propylene glycol monomethyl ether (36° C.)(numbers in parentheses indicate flash point). One type of glycol monoether may be used independently, or two or more types may be used together.

It is preferable that the flash point of the glycol monoether is 70 to 200° C., more preferably 75 to 190° C., and still more preferably 75 to 180° C. By the flash point of the glycol monoether being within the above ranges, the drying properties tend to further improve.

It is preferable that the content of the glycol monoether solvent is 4.0 to 20 mass % with respect to the total amount of the ink composition, 5.0 to 15 mass % is more preferable, and 5.0 to 10 mass % is still more preferable. By the content of the glycol monoether solvent being 4.0 mass % or more, the printing unevenness of the obtained recording material tends to be suppressed, the dot size to further increase, and the drying properties to further improve. By the content of the glycol monoether solvent being 20 mass % or less, the gloss and the color fastness to rubbing of the obtained recording material tends to further improve.

### Water

The ink composition of the embodiment may further contain water. Examples of the water include pure waters such as ion-exchange water, ultrafiltered water, reverse osmosis water, and distilled water, and waters from which as many impurities are removed as possible, such as ultrapure water.

It is preferable that the content of the water is 3.0 mass % or less to the total content amount of the ink composition, 2.0 mass % or less is more preferable, and 1.0 mass % or less is still more preferable. Although not particularly limited, it is preferable that the lower limit of the content of water is 0 mass %. By the content of the water being within this range, the storage stability of the ink composition tends to further improve.

### Resin

The ink composition may further include a resin. By including a resin, the abrasion resistance tends to further improve. Although not particularly limited, examples of the resin include fibrous resins, such as vinyl chloride resins, vinyl chloride-vinyl acetate copolymer resins, and cellulose acetate butylate; (meth)acrylic resins, styrene (meth)acrylic resins, rosin-modified resins, phenol resin, terpene resins, polyester resins, polyamide resins, epoxy resins, and vinyl toluene-α-methylstyrene copolymer resins. Among these, (meth)acrylic acid is preferable. By including a resin, the abrasion resistance tends to further improve.

It is preferable that the content of the resin is 0.10 to 7.5 mass % with respect to the total amount of the ink composition, 0.50 to 5.0 mass % is more preferable, and 1.0 to 2.5 mass % is still more preferable. By the content of the resin being within this range, the abrasion resistance of the ink composition tends to further improve with the viscosity of the ink composition suppressed to be low.

### Surfactant

The ink composition may further include a surfactant. Although not particularly limited, examples of the surfactant include polyoxyalkylene alkyl ether, acetylene glycol-based surfactants, fluorine based surfactants, and silicone based surfactants. Among these, a silicone-based surfactant is preferable from the viewpoint of improving the color fastness to rubbing of the recording material.

It is preferable that the content of the surfactant is 0.10 to 7.5 mass % with respect to the total amount of the ink composition, 0.50 to 5.0 mass % is more preferable, and 1.0 to 2.5 mass % is still more preferable.

### Dispersant

The ink composition may further include a dispersant by which the pigment is dispersed. Although not particularly limited, examples of the dispersant include anionic dispersants, nonionic dispersants, and macromolecular dispersants.

Although not particularly limited, examples of the anionic dispersant include formalin condensates of aromatic sulfonic acid, formalin condensates of β-naphthalene sulfonic acid, formalin condensates of alkylnaphthalene sulfonic acid and formalin condensates of creosote oil sulfonic acid.

Although not particularly limited, examples of the aromatic sulfonic acid include alkyl naphthalene sulfonic acids such as creosote oil sulfonic acid, cresol sulfonic acid, phenol sulfonic acid, β-naphthol sulfonic acid, methylnaphthalene sulfonic acid, and butyl naphthalene sulfonic acid; mixtures of β-naphthalene sulfonic acid and β-naphthol sulfonic acid, mixtures of creosote oil sulfonic acid and 2-naphthol-6-sulfonic acid, and lignin sulfonic acid.

Although not particularly limited, examples of the non-ionic dispersant include ethylene oxide adducts of phytosterol, and ethylene oxide adducts of cholestanol.

Although not particularly limited, examples of the macromolecular dispersant include a polyacrylic acid moiety alkyl ester, a polyalkylene polyamine, polyacrylic acid salts, styrene-acrylic polymerization products, and vinyl naphthalene-maleic acid polymerization products.

It is preferable that the content of the dispersant is 0.10 to 7.5 mass % with respect to the total amount of the ink composition, 0.50 to 5.0 mass % is more preferable, and 1.0 to 2.5 mass % is still more preferable.

### Other Components

In order to favorably maintain the storage stability of the ink composition and the discharge stability from the head, in order to improve clogging, or in order to prevent deterioration of the ink composition, it is possible to add, as appropriate, various additives such as dissolution aids, viscosity adjusters, pH adjusters, antioxidants, antifungal agents, preservatives, anti-corrosive agents and chelating agents for trapping metal ions that influence the dispersion.

### Ink Jet Recording Method

The ink jet recording method of the embodiment includes an attachment step in which the solvent-based ink jet ink composition is attached to a recording medium.

In the attachment step, it is preferable to include an attachment step in which the attachment amount of the ink composition to the recording medium with respect to the attachment region of the ink composition is 10 to 70 mg/inch², 15 to 60 mg/inch² is more preferable, and 20 to 50 mg/inch² is still more preferable. Even if the attachment amount is within the above ranges, it is possible for the ink composition of the embodiment to obtain a recording material with superior drying properties, and with superior color fastness to rubbing and fillability. The attachment step including an attachment step with a predetermined attachment amount signifies including at least an attachment step with the attachment amount. Among the more preferable attachment steps, it is preferable to include an attachment step in which the attachment amount is an attachment amount within the above ranges as an attachment step with the maximum attachment amount.

### EXAMPLES

Below, the examples and the comparative examples of the invention will be more specifically described. The invention is not limited by any of the following examples.

### Material for Ink Composition

The main materials for the ink composition used in the examples and the comparative examples are as follows.

### Pigments

JR-806 (titanium oxide, manufactured by Tayca Corporation)
JR-301 (titanium oxide, manufactured by Tayca Corporation)

### Dispersant

SOLSPERSE 3000 (polyester polyamide resin, manufactured by Lubrizol Co., Ltd.)

### Solvent a

GBL (δ-butyrolactone)

### Solvent b

DEGMEE (diethylene glycol methylethyl ether, flash point 64° C.)
DEGBME (diethylene glycol butylmethyl ether, flash point 94° C.)
DEGdEE (diethylene glycol diethyl ether, flash point 70.8° C.)
TetraEGmBE (tetraethylene glycol monobutyl ether, flash point 177° C.)

### Solvent c

DPGmME (dipropylene glycol monomethyl ether, flash point 79° C.)
DEGdME (diethylene glycol dimethyl ether, flash point 57° C.)

### Solvent d

Equamide M100 (amide-based solvent, Idemitsu Kosan Co., Ltd.)

### Surfactant

BYK-340 (silicone-based surfactant, manufactured by BYK-Chemie Japan Co., Ltd.)

### Resin

G-1000P (methacrylic resin “Parapet”, manufactured by Kuraray Co., Ltd.)

### Preparation of Ink Composition

Each material was mixed with constitutions shown in the following Table 1 and sufficiently stirred, thereby obtaining each ink composition. Specifically, first, the solvent of each material were mixed, to obtain a mixed solvent. A portion of the obtained mixed solvent was mixed with Solsperse 3000 (manufactured by Lubrizol, Co., Ltd.), and thereafter, titanium oxide JR-806 (manufactured by Tayca Corporation) was added, and preliminarily dispersed using a homogenizer. Thereafter, the resultant was dispersed with a bead mill, and a titanium oxide dispersoid was obtained. Next, a portion of the mixed solvent was mixed with Parapet G-1000P (manufactured by Kuraray Co., Ltd.) to obtain a resin solution. Finally, the titanium oxide dispersoid, the resin solution, the remainder of the mixed solution, and BYK340 (manufactured by BYK-Chemie Japan Co., Ltd.) were mixed, and the ink composition was prepared. In Example 6, the ink composition was obtained similarly to above other than using JR-301 (manufactured by Tayca Corporation) instead of JR-806 (manufactured by Tayca Corporation). In the above Table 1, the unit of the numerical values is mass %, and the total is 100.0 mass %.

### PVC Solubility Test

0.5 g of polyvinyl chloride (PVC Straight Polymer TK-800, Shin-Etsu Chemical Co., Ltd.) and 50 g of solvent were mixed in a glass bottle, and stirred for five minutes at 25° C. Thereafter, the resultant was left to stand, and the height X of the solvent liquid surface from the bottom of the glass bottle and the height Y from the bottom of the glass bottle in which the swollen or dissolved polyvinyl chloride power is distributed were measured at 25 seconds after being left. The ratio Y/X is obtained with the obtained X and Y and made the index of the dissolving power of polyvinyl chloride for each solvent. Because the Y/X of the γ-butyrolactone of the embodiments was 0.8, each solvent was defined as follows.
Solvent b: Y/X<0.7
Solvent c: 0.7≦Y/X≦0.9
Solvent d: 0.9<Y/X

TABLE

| | | | | | | | | | | Comparative | | | |
|---|---|---|---|---|---|---|---|---|---|---|---|---|---|
| | | | Example | | | | | | | Example | | | |
| | | | 1 | 2 | 3 | 4 | 5 | 6 | 7 | 1 | 2 | 3 | 4 |
| Pigment | | JR-806 | 17 | 17 | 17 | 17 | 17 | 0 | 17 | 17 | 17 | 17 | 17 |
| | | JR-301 | 0 | 0 | 0 | 0 | 0 | 17 | 0 | 0 | 0 | 0 | 0 |
| Dispersant | | Solsperse | 2 | 2 | 2 | 2 | 2 | 2 | 2 | 2 | 2 | 2 | 2 |
| | | 3000 | | | | | | | | | | | |
| Solvent a | | GBL | 2 | 5 | 7 | 5 | 5 | 2 | 4 | 0 | 10 | 5 | 2 |
| Solvent b | Solvent b1 | DEGMEE | 35 | 37 | 40 | 0 | 20 | 35 | 25 | 37 | 32 | 20 | 10 |
| | Solvent b2 | DEGBME | 0 | 0 | 20 | 0 | 42 | 0 | 0 | 0 | 0 | 20 | 0 |
| | | DEGdEE | 30 | 30 | 0 | 67 | 0 | 30 | 20 | 30 | 25 | 0 | 5 |
| | | TetraEGmBE | 0 | 0 | 10 | 0 | 5 | 0 | 0 | 0 | 0 | 5 | 0 |

| | | | | | | | | | | | | |
|---|---|---|---|---|---|---|---|---|---|---|---|---|
| Solvent c | DPGmME | 10 | 0 | 0 | 0 | 0 | 10 | 18 | 5 | 10 | 22 | 10 |
| | DEGdME | 0 | 0 | 0 | 0 | 0 | 0 | 10 | 0 | 0 | 0 | 50 |
| Solvent d | Equamide | 0 | 5 | 0 | 5 | 5 | 0 | 0 | 5 | 0 | 5 | 0 |
| | M100 | | | | | | | | | | | |
| Surfactant | BYK340 | 2 | 2 | 2 | 2 | 2 | 2 | 2 | 2 | 2 | 2 | 2 |
| Resin | G-1000P | 2 | 2 | 2 | 2 | 2 | 2 | 2 | 2 | 2 | 2 | 2 |

| Total | | 100 | 100 | 100 | 100 | 100 | 100 | 100 | 100 | 100 | 100 | 100 |
|---|---|---|---|---|---|---|---|---|---|---|---|---|
| Content of solvent a | | 2 | 5 | 7 | 5 | 5 | 2 | 4 | 0 | 10 | 5 | 2 |
| Total content of solvent b | | 65 | 67 | 70 | 67 | 67 | 65 | 45 | 67 | 57 | 45 | 15 |
| Total content of solvent b1 | | 35 | 37 | 40 | 0 | 20 | 35 | 25 | 37 | 32 | 20 | 10 |
| Evaluation | Printing unevenness | 6 | 6 | 6 | 5 | 5 | 6 | 6 | 3 | 6 | 6 | 6 |
| Results | Gloss | 6 | 6 | 5 | 6 | 6 | 6 | 5 | 6 | 2 | 3 | 2 |
| | Dot size | 6 | 5 | 6 | 5 | 5 | 6 | 6 | 6 | 2 | 2 | 2 |
| | Color fastness to | 5 | 6 | 6 | 6 | 6 | 5 | 6 | 2 | 6 | 6 | 6 |
| | rubbing | | | | | | | | | | | |
| | Surface drying | 6 | 5 | 6 | 4 | 5 | 6 | 6 | 3 | 6 | 6 | 6 |
| | properties | | | | | | | | | | | |
| | Printed matter mist | 4 | 4 | 4 | 4 | 4 | 3 | 4 | 4 | 4 | 4 | 4 |

### Printing Unevenness

Each ink composition obtained as above was charged to a printer SC-S50650 manufactured by Seiko Epson Corp., solid printing was performed on a vinyl chloride banner sheet (manufactured by 3M Limited, trade name IJ51) at a recording resolution of 1440×1440 dpi and an application amount of 22 mg/inch², and the obtained recording material was dried for 60 minutes. Thereafter, the printing surface was observed visually and using an optical microscope and then evaluated on scale of 1 to 6 with 6 points as no printing unevenness.

### Gloss

Each ink composition obtained as above was charged to a printer SC-S50650 manufactured by Seiko Epson Corp., solid printing was performed on a glossy vinyl chloride banner sheet (manufactured by Roland DG Corporation, trade name SV-G-1270G) at a recording resolution of 1440×1440 dpi and an application amount of 22 mg/inch², and the obtained recording material was dried for one day at room temperature. The 20° gloss of the solid printing portion was measured with a MULTI GLOSS 268 (manufactured by KONICA MINOLTA, Inc.), and evaluated with the following evaluation criteria. The higher the glossiness, the more the ink composition spread on the recording medium, and this signifies that a recording material with good fillability was obtained.

### Evaluation Criteria

1: Glossiness is less than 26
2: Glossiness is 26 or more to less than 28
3: Glossiness is 28 or more to less than 30
4: Glossiness is 30 or more to less than 32
5: Glossiness is 32 or more to less than 34
6: Glossiness is 34 or more

### Dot Size

Each ink composition obtained as above was charged to a printer SC-550650 manufactured by Seiko Epson Corp., a nozzle check patter was printed on a vinyl chloride banner sheet (manufactured by 3M Limited, trade name IJ51). The obtained recording material was dried for 60 minutes. Thereafter, the dot size was observed using an optical microscope, and evaluated with the following evaluation criteria. The larger the dot size, the more the ink composition spread on the recording medium, and this signifies that a recording material with good fillability was obtained.

### Evaluation Criteria

1: Dot size 20 μm or less
2: Dot size greater than 20 μm to 30 μm or less
3: Dot size greater than 30 μm to 40 μm or less
4: Dot size greater than 40 μm to 50 μm or less
5: Dot size greater than 50 μm to 60 μm or less
6: Dot size greater than 60 μm

### Color Fastness to Rubbing

Each ink composition obtained as above was charged to a printer SC-530650 manufactured by Seiko Epson Corp., solid printing was performed on a glossy vinyl chloride sheet (manufactured by Roland DG Corporation, trade name SV-G-1270G) at a recording resolution of 1440×1440 dpi and an application amount of 22 mg/inch², and the obtained recording material was dried for one day at room temperature. Next, a dry test was performed using a type I tester based on JIS L 0849. Thereafter, the color transfer OD value of the examination banner sheet was measured with a Spectrolino (manufactured by Gretag Macbeth Co., Ltd.), and evaluated according to the following evaluation criteria.

### Evaluation Criteria

1: Color Transfer OD is 0.40 or more
2: Color Transfer OD is 0.35 or more to less than 0.40
3: Color Transfer OD is 0.30 or more to less than 0.35
4: Color Transfer OD is 0.25 or more to less than 0.30
5: Color Transfer OD is 0.20 or more to less than 0.25
6: Color Transfer OD is less than 0.20

### Surface Drying Properties

Each ink composition obtained as above was charged to a printer SC-530650 manufactured by Seiko Epson Corp., solid printing was performed on a glossy vinyl chloride banner sheet (manufactured by Roland DG Corporation, trade name SV-G-1270G) at a recording resolution of 1440×1440 dpi and an application amount of 22 mg/inch², and the obtained recording material was dried for five minutes at room temperature. Next, scratching of the printing surface after being wound using the winding device was observed. Through observation, the proportion of the area having scratching was calculated by measuring the surface roughness with a laser microscope (manufactured by Keyence Corporation, model number VK-8700 Generation 2), and evaluated according to the following evaluation criteria.

### Evaluation Criteria

1: Scratching area is greater than 40%
2: Scratching area is greater than 30% to 40% or less
3: Scratching area is greater than 20% to 30% or less
4: Scratching area is greater than 10% to 20% or less
5: Scratching area is 10% or less
6: No scratching

### Printed Matter Mist Evaluation

Each ink composition obtained as above was charged to a printer SC-550650 manufactured by Seiko Epson Corp., solid printing was performed continuously for 10 minutes at a width of 30 cm, a recording resolution of 1440×1440 dpi, and an attachment amount of 22 mg/inch² on a transparent PET film (manufactured by Roland DG Corporation, trade name SP-CL-515T), and the obtained recording material was dried for one day at room temperature to obtain a printing sample. Next, the non-printing portion in the vicinity of carriage scanning direction end portion of the solid printing portion was observed visually and with a magnifying glass, and contamination defects of mist that flies and is attached were confirmed, and evaluated according to the following evaluation criteria.

### Evaluation Criteria

1: Mist attachment strongly noticeable
2: Mist attachment present and easily visibly recognized
3: Mist attachment is recognized, but slight
4: Mist attachment does not occur

The entire disclosure of Japanese Patent Application No. 2015-047608, filed Mar. 10, 2015 is expressly incorporated by reference herein.

What is claimed is:

1. A solvent-based ink jet ink composition comprising:
a pigment;
a solvent a that is a cyclic ester; and
a solvent b with a lower dissolving power of polyvinyl chloride than the solvent a,
wherein a content of the solvent a is 1.0 to 7.0 mass %, and
a content of the solvent b is 10 parts by mass or more to one part by mass of the content of the solvent a.

2. The solvent-based ink jet ink composition according to claim 1,
wherein the pigment includes a white pigment.

3. The solvent-based ink jet ink composition according to claim 1, further comprising:
a glycol monoether solvent,
wherein a content of the glycol monoether solvent is 4.0 to 20 mass %.

4. The solvent-based ink jet ink composition according to claim 1,
wherein the solvent b includes a compound represented by the following formula (1).
R¹O—(R²O)ₘ—R³ Formula (1)
(in the formula, R¹ is a hydrogen atom or an alkyl group with 1 to 4 carbon atoms, R² is an alkylene group with 2 or carbon atoms, R³ is an alkyl group with 1 to 4 carbon atoms, and m is an integer of 2 to 4.)

5. The solvent-based ink jet ink composition according to claim 1,
wherein the solvent b includes a compound b1 with a flash point of 70° C. or less, and
a content of the compound b1 is 50 mass % or more to the total amount of the solvent b.

6. The solvent-based ink jet ink composition according to claim 5,
wherein the content of the compound b1 is 10 parts by mass or more to one part by mass of the content of the solvent a.

7. The solvent-based ink jet ink composition according to claim 1,
wherein the solvent-based ink jet ink composition is used in an ink jet recording method including attaching in which the solvent-based ink jet ink composition is attached to a recording medium, and
the ink jet recording method includes attaching in which an attachment amount in an attachment region of the recording medium is 10 to 70 mg/inch².

8. The solvent-based ink jet ink composition according to claim 1, further comprising:
water,
wherein a content of the water is 3.0 mass % or less.

9. An ink jet recording method, comprising:
attaching the solvent-based ink jet ink composition according to claim 1 to a recording medium.

10. An ink jet recording method, comprising:
attaching the solvent-based ink jet ink composition according to claim 2 to a recording medium.

11. An ink jet recording method, comprising:
attaching the solvent-based ink jet ink composition according to claim 3 to a recording medium.

12. An ink jet recording method, comprising:
attaching the solvent-based ink jet ink composition according to claim 4 to a recording medium.

13. An ink jet recording method, comprising:
attaching the solvent-based ink jet ink composition according to claim 5 to a recording medium.

14. An ink jet recording method, comprising:
attaching the solvent-based ink jet ink composition according to claim 6 to a recording medium.

15. An ink jet recording method, comprising:
attaching the solvent-based ink jet ink composition according to claim 7 to a recording medium.

16. An ink jet recording method, comprising:
attaching the solvent-based ink jet ink composition according to claim 8 to a recording medium.
